(19) United States
(12) Patent Application Publication
(10) Pub. No.: US 2015/0258601 A1
(43) Pub. Date: Sep. 17, 2015

(54) DRILLING-OUT AID DEVICE FOR ASSISTING IN DRILLING OUT A RIVET

(71) Applicant: AIRBUS OPERATIONS GMBH, Hamburg (DE)

(72) Inventors: Rüdiger BOTHA, Hamburg (DE); Hamid EBRAHIMI, Scharnebeck (DE); Christian RESE, Hamburg (DE)

(21) Appl. No.: 14/639,609

(22) Filed: Mar. 5, 2015

(30) Foreign Application Priority Data
Mar. 12, 2014 (DE) 10 2014 204 588.6

(51) Int. Cl. B21J 15/50; B23B 49/02

(52) U.S. Cl. CPC B21J 15/50; B23B 49/02; B23B 2260/026

(57) ABSTRACT

A drilling-out aid device for assisting in drilling out a rivet, in particular a blind rivet, by a drilling tool, includes a proximal handle portion for handling the drilling-out aid device; a guide device for centrically guiding a drilling shaft of the drilling tool; a distal rivet-head receiving device for centrically orientating the drilling-out aid device on the head of the rivet to be drilled out; and a rivet-head pressing device, which is mounted displaceably in the longitudinal direction of the drilling-out aid device relative to the rivet-head receiving device to apply a centric gripping force to the head of the rivet to be drilled out.

### CROSS-REFERENCE TO RELATED APPLICATION

This application claims priority to DE 10 2014 204 588.6 filed Mar. 12, 2014, the entire disclosure of which is incorporated by reference herein.

### TECHNICAL FIELD

The disclosure herein relates to a drilling-out aid device for assisting in drilling out a rivet, in particular a blind rivet, using a drilling tool.

### BACKGROUND

Although applicable to any desired technical fields, the disclosure herein and the problems on which it is based are described in greater detail in relation to the field of aviation and aerospace, and in particular in relation to an aeroplane.

In aircraft construction, riveting is one of the most important connection types, in particular for interconnecting sheet metal parts made for example of light metal alloys or other materials. The rivet connections have to comply with particular regulations so as to be able to ensure a predetermined quality of the rivet connection and to ensure that the forces occurring in the aeroplane when under load are absorbed. During manufacture, when for example longitudinal seams, transverse joints or former couplings are machined, the components to be joined are connected using blind rivets (also referred to as pop rivets). The blind rivets take on a plurality of functions. For example, they hold the components to be joined in position, in such a way that no component shift can occur when these components are machined further. Further, the blind rivets ensure a uniform distribution of the sealing masses between the components to be joined. In addition, the blind rivets ensure sufficient gripping of the components to be joined, until for example a sealing mass applied in liquid form has dried for further machining.

Often, the introduction of blind rivets constitutes an auxiliary construction, since in the field of aviation and aerospace the blind rivets are replaced with other rivets, for example after a sealing mass between the components to be joined has dried, in such a way that the introduced blind rivets no longer have any intrinsic function, since the final riveting has already been started or the components to be joined have to be separated again for cleaning, trimming or the like. To remove the introduced blind rivets, they are drilled out using a drilling tool. In general, the same drilling tool with which the pre-drilling into the components to be joined was carried out is used for this purpose.

Thus far, however, the person carrying out a drilling-out process of this type has had to exercise great care.

### SUMMARY

One idea of the disclosure herein is therefore to improve the drilling-out process and simplify it for the person carrying out the drilling-out.

The concept behind the disclosure herein is that the drilling-out aid device for assisting in drilling out a rivet, in particular a blind rivet, by a drilling tool comprises a proximal handle portion for handling the drilling-out aid device; a guide device for centrically guiding a drilling shaft of the drilling tool; a distal rivet-head receiving device for centrically orientating the drilling-out aid device on the head of the rivet to be drilled out; and a rivet-head pressing device, which is mounted displaceably in the longitudinal direction of the drilling-out aid device relative to the rivet-head receiving device in order to apply a centric gripping force to the head of the rivet to be drilled out.

The disclosure herein thus has the advantage that the rivet to be drilled out is gripped in place and centrically secured in place prior to the drilling-out process in such a way that the drilling tool can ensure a high-quality and virtually error-free drilling-out process. Slipping of the rotating drilling tool from the head of the blind rivet to be drilled out is further advantageously prevented in such a way that damage to adjacent material can be prevented. Entrainment in rotation of the blind rivet to be drilled out is additionally advantageously prevented, in such a way that the blind rivet to be drilled out can be drilled out in a simple manner. Advantageous configurations of and improvements to the drilling-out aid device can be found in the claims.

In one embodiment, the proximal handle portion, the guide device and the rivet-head pressing device form a base body of the drilling-out aid device, on the distal outer periphery of which base body an outer sleeve comprising the rivet-head receiving device is mounted displaceably in the longitudinal direction relative to the base body. As a result, on the one hand the drilling-out aid device can be positioned and orientated centrically with respect to the rivet head of the rivet to be drilled out to prepare the drilling process, and on the other hand the rivet can be gripped in place in the centric position by corresponding adjustment of the rivet-head pressing device relative to the outer sleeve by way of the applied pressure on the rivet head. As a result, a predetermined, optimised drilling-out process is ensured in a simple and cost-effective manner.

In a further development, the distal rivet-head receiving device is in the form of a receiving opening, adapted to the diameter of the rivet head to be drilling out, on the underside of the outer sleeve which is displaceable in the longitudinal direction. This results in a centric orientation of the drilling-out aid device by simply placing it on the head of the rivet to be drilled out, in such a way that the rivet head is received in an approximately exact fit in the receiving opening and the drilling-out aid device is adjustable in a suitable manner.

In a further development, the displaceable outer sleeve is mounted so as to be biased on the base body by a spring device and an associated securing structure. The securing structure is advantageously in the form of a fixing pin or the like, engaging in a recess, having clearance, in the outer peripheral region of the rivet-head pressing device, and the spring device is advantageously in the form of an annular rubber ring or the like. This ensures that the outer sleeve is attached stably to the base body in such a way that, in the context of the freedom of movement of the securing pin in the associated recess, said outer sleeve is adjustable relative to the base body, via a predetermined longitudinal portion, in order to apply a gripping force to the head of the rivet to be removed. Further, as a result, it is ensured that the outer sleeve is disassembled in a simple manner, and as a result a component, for example the rubber ring, is exchanged in the event of wear.

In a further development, the rivet-head pressing device is in the form of a distal contact edge, having a central through-opening and adapted to the shape of the head of the rivet to be drilled out, of the base body. Advantageously, increased static friction is brought about between the contact edge and the rivet head, for example as a result of a surface, formed accordingly in terms of shape or material, of the contact edge. As a result, it is advantageously achieved that, owing to the relative movement between the rivet-head pressing device and the base body, a defined gripping force can be brought about by the user in a simple manner by placing the base body on the rivet head of the rivet to be drilled out.

In a further development, the drilling-out aid device is dimensioned in such a way that the head of the rivet to be drilled out can be received centrically in the receiving opening, and can be secured in place by exerting pressure on the base body counter to the spring force of the spring device, by placing under pressure the distal contact edge on the head of the rivet to be drilled out. It is therefore advantageous to dimension the drilling-out aid device in accordance with the dimensions of the respective rivets to be drilled out. Since merely a small number of standard dimensions for blind rivets are provided, it is advantageous also merely to have to produce a small number of differently dimensioned drilling-out aid devices.

In a further embodiment, the proximal handle portion, the guide device and the rivet-head receiving device form a base body, comprising an internal space, of the drilling-out aid device, in the internal space of which base body the rivet-head pressing device is mounted displaceably in the longitudinal direction relative to the base body, at least in part. In this way too, it is again advantageously achieved that the base body ensures a centric orientation of the drilling-out aid device relative to the rivet head of the rivet to be drilled out, a gripping force for positioning the rivet head securely in position during the drilling-out process being brought about by way of the relative movement between the base body and the rivet-head pressing device. This results in a high-quality drilling-out process, without a risk of slipping or of the rivet to be drilled out being entrained in rotation.

In a further development, the distal rivet-head receiving device is in the form of a receiving opening, adapted to the diameter of the rivet head to be drilled out, on the underside of the base body. As a result, the user can achieve the desired central orientation merely by placing the drilling-out aid device on the associated rivet head.

In a further development, the rivet-head pressing device comprises a spring device mounted in the base body and a pressure disc which has a central through-opening and which is resiliently biased towards the underside of the drilling-out aid device by the spring device. As a result, it is ensured in a simple and cost-effective manner that the head of the rivet to be drilled out, and thus the rivet to be drilled out itself, is gripped in place prior to and during the drilling-out process, in such a way that the rivet is advantageously prevented from spinning.

In a further development, the pressure disc comprises a pressure face having an increased coefficient of static friction in relation to the head of the rivet to be drilled out. As a result, even with a small application of force by the user, a high gripping force can be exerted on the rivet head, in such a way that it is secured in position during the drilling process.

In a further development, the drilling-out aid device is dimensioned in such a way that the head of the rivet to be drilled out can be received centrically in the receiving opening and can be secured in place by exerting pressure on the base body counter to the spring force of the spring device, by placing under pressure the pressure disc on the head of the rivet to be drilled out. As a result, a cost-effective drilling-out aid tool is produced, which can be handled by the user in a simple manner and which can be used with a small application of force.

In a further development, the drilling-out aid device comprises a securing device, in particular a securing ring, which is formed so as to be dismountable and which secures the guide device, the spring device and/or the pressure disc in place when mounted. As a result, in the event of wear on the guide device, the spring device and/or the pressure disc, one or more of these components can be replaced in a simple and cost-effective manner.

In a further development, the drilling-out aid device comprises a transversely extending through-opening for discharging drilling chips. This advantageously ensures that the chips which occur during the drilling process are transported out of the danger region and thus do not obstruct the drilling-out process or even lead to damage to the surfaces of the components to be joined.

In a further development, the guide device is in the form of a guide bushing, adapted to the drilling tool to be used and made for example of steel, for centrically guiding the drilling shaft of the drilling tool. As a result, tilting or slipping of the drilling tool during the drilling process and damage to the surface of the component to be joined are advantageously prevented.

### BRIEF DESCRIPTION OF THE DRAWINGS

In the following, the disclosure herein is described in greater detail by way of embodiments with reference to the accompanying drawings, in which:

FIG. 1 is a perspective view of a drilling-out aid device in accordance with a first embodiment of the disclosure herein;

FIG. 2 is a cross-sectional view of the drilling-out aid device of FIG. 1;

FIG. 3 is an exploded view of the drilling-out aid device of FIGS. 1 and 2;

FIG. 4 is a perspective view of a drilling-out aid device in accordance with a second embodiment of the disclosure herein;

FIG. 5 is a cross-sectional view of the drilling-out aid device according to FIG. 4; and

FIG. 6 is an exploded view of the drilling-out aid device according to FIGS. 4 and 5.

In the drawings, like reference numerals denote like or functionally equivalent components unless otherwise specified.

### DETAILED DESCRIPTION

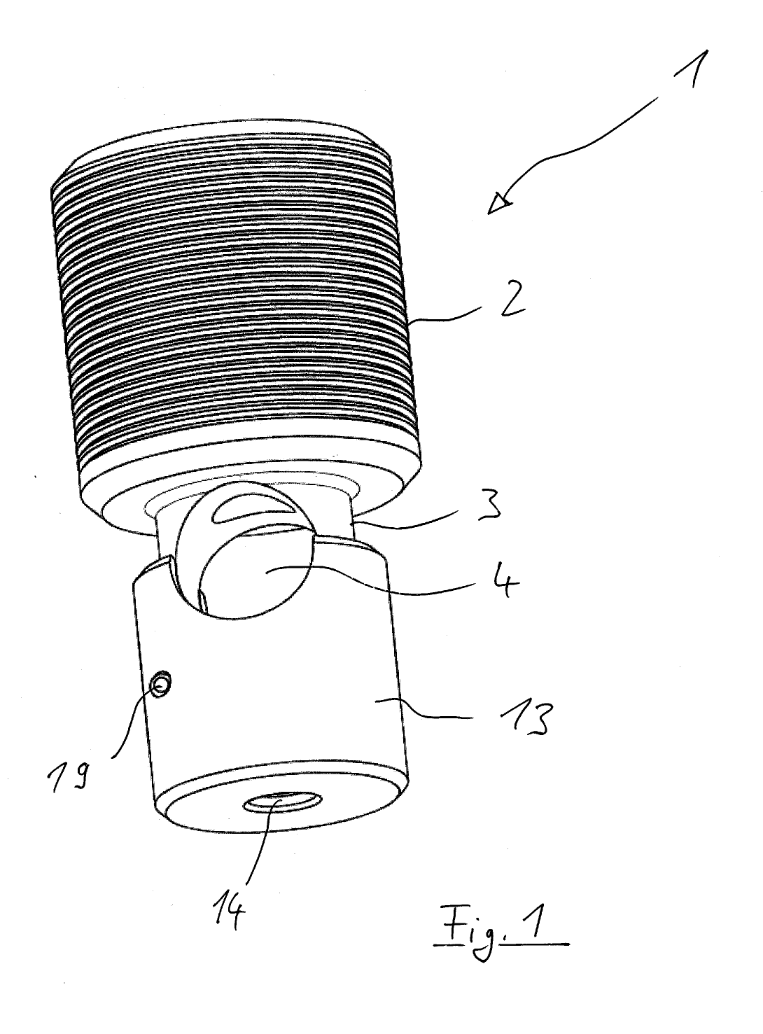

In the following, a drilling-out aid device 1 in accordance with a first embodiment of the disclosure herein is described in greater detail with reference to FIGS. 1 to 3.

As is illustrated for example in FIG. 1, the drilling-out aid device 1 in accordance with the present embodiment comprises a proximal handle portion 2 having a hollow cylindrical shape. The handle portion 2 is used as a grip by the user, and can in this case advantageously have a profiled surface. In the embodiment shown in FIG. 1, the handle portion 2 has for example a radially extending ribbing, which is intended to ensure an improved grip during a pressing process directed in the longitudinal direction. However, it is obvious to a person skilled in the art that any other type of profiling which ensures an improved grip is also possible. Naturally, it is also possible not to provide ribbing of this type.

The drilling-out aid device 1 according to the first preferred embodiment further comprises a portion 3 having a hollow cylindrical shape, which extends downwards in the longitudinal direction, is tapered with respect to the handle portion 2, and comprises a transversely extending through-opening 4, which is used inter alia for discharging drilling chips during the drilling process. The shape and arrangement of this through-opening 4 may naturally also be implemented differently. All that is of decisive importance is that there is a possibility for the produced drilling chips to exit the drilling-out aid device 1 from the internal region of the drilling-out aid device 1.

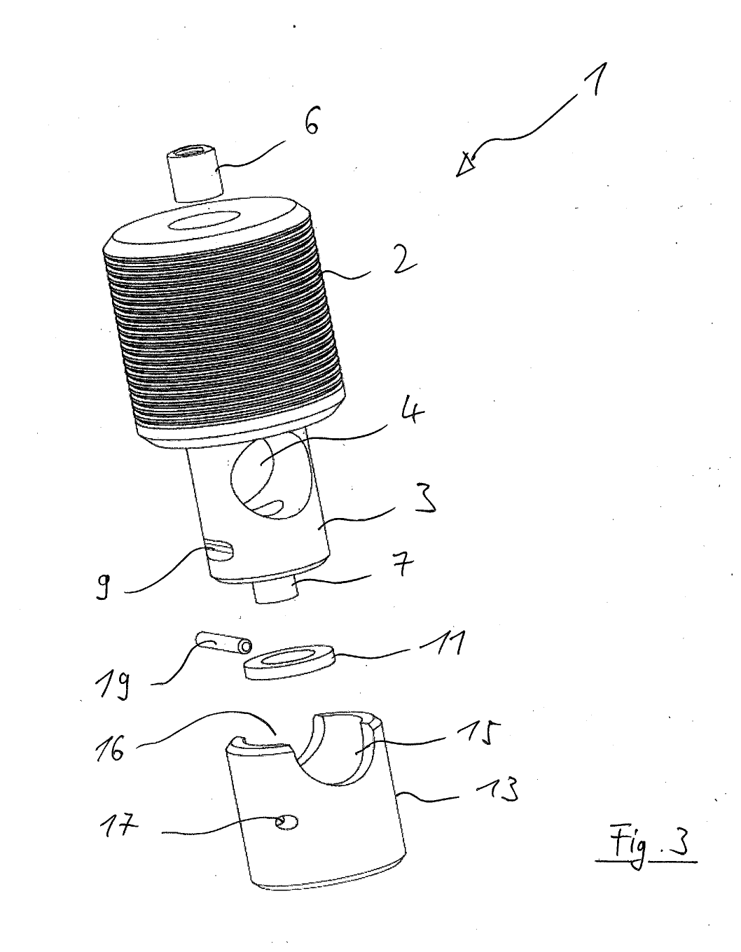

As is shown in particular in FIG. 3, the tapered portion 3 of the drilling-out aid device 1 comprises a recess 9, which is provided at a predetermined width and depth, preferably in the form of an elongate notch, in the outer peripheral region of the tapered portion 3. This recess 9 corresponds to an associated securing pin 19, which is disclosed in greater detail below.

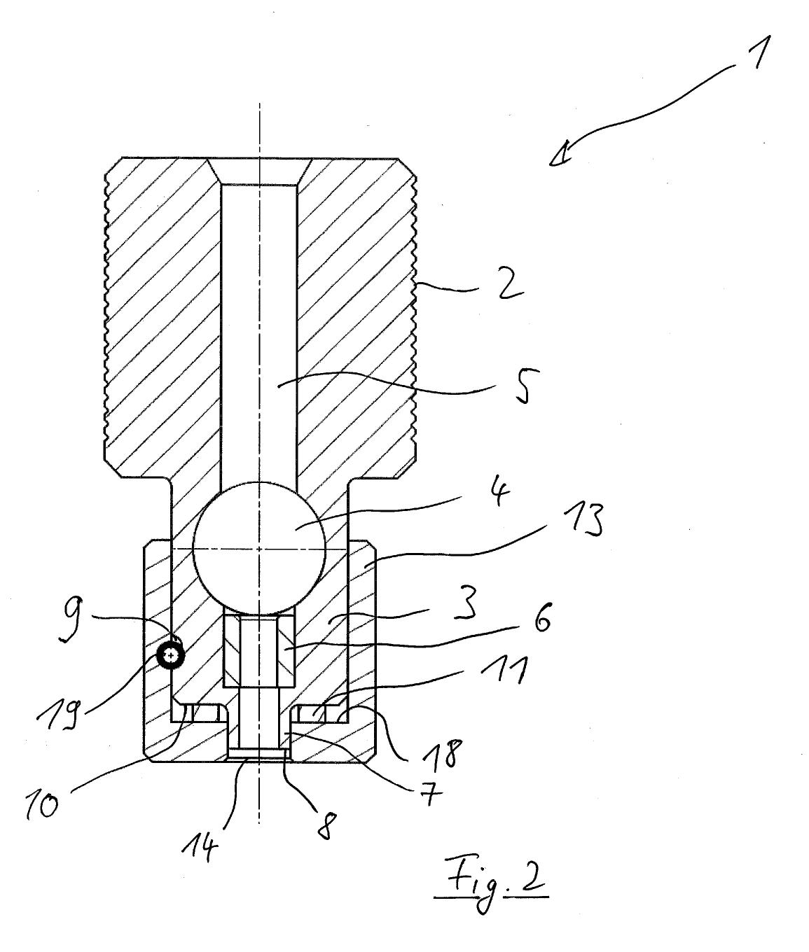

As can be seen in particular in FIG. 2, the drilling-out aid device 1 in accordance with the first preferred embodiment comprises a substantially centrally extending through-hole 5 which is used for axially guiding the shaft of the used drilling tool in the lower region of the receiving portion of a guide bushing 6. The guide bushing 6 is in particular in the form of a steel drilling bushing and is for example pressed into the through-hole 5 directly below the transversely extending through-opening 4.

The drilling-out aid device 1 is preferably made of a hard material, for example steel or aluminum. However, other suitable materials are also conceivable.

As well as the aforementioned ejection of chips, the transversely extending through-opening 4 is further used for ejecting a damaged guide bushing 6 in the event of wear thereof. For this purpose, the guide bushing is displaced in the longitudinal direction from the lower face of the drilling-out aid device 1 towards the transversely extending through-opening 4, via which it is ejected. Subsequently, the damaged guide bushing 6 is replaced with a new one, which can in turn be inserted into the corresponding portion of the through-hole 5 through the transversely extending through-opening 4.

As can be seen in particular in FIGS. 2 and 3, in the distal end region the drilling-out aid device 1 comprises a projection 7 in the shape of a hollow cylinder, which tapers further than the tapered portion 3 and in which the through-hole 5 and the hole of the guide bushing 6 are continued in the longitudinal direction for guiding the drilling shaft of the drilling tool. The internal diameter of the hole provided in the tapered projection 7 approximately corresponds to the internal diameter of the hole in the guide bushing 6. The downwardly directed annular end face 8 of the tapered projection 7 forms a contact face 8 for contact with the surface of the head of the rivet to be drilled out. The contact face 8 may advantageously comprise a surface having an increased static friction coefficient and/or a geometric shape for increasing the static friction.

In accordance with the first embodiment, the handle portion 2, the tapered portion 3 and the tapered portion 7 preferably form a base body of the drilling-out aid device 1, which may in particular be formed in a single piece.

The drilling-out aid device 1 in accordance with the first embodiment further comprises a spring device in the form of a rubber ring 11, which has an internal diameter which is larger than the external diameter of the tapered projection 7, in such a way that the rubber ring 11 can be arranged concentrically over the tapered projection 7. The spring device may also for example be in the form of a flattened O-ring, plate spring or the like.

The drilling-out aid device 1 in accordance with the first embodiment further comprises an outer sleeve 13, which is for example approximately thimble-shaped and which is preferably dimensioned in such a way that it can be applied displaceably, at least in portions, to the tapered portion 3 of the drilling-out aid device 1 so as to slide relative thereto. The outer sleeve 13 also receives the tapered projection 7, and comprises, on the lower end face, in the distal end region, a receiving opening 14, into which the tapered projection 7 protrudes, at least in part, and the dimensioning of which is adapted to the geometric dimensioning of the rivet head of the rivet to be drilled out in such a way that the rivet head to be received can be introduced in an approximately exact fit.

The outer sleeve 13 of the face opposing the receiving opening 14 further comprises two mutually opposing approximately semi-circular recesses 15, 16, which are each flush with the transversely extending through-opening 4 when the outer sleeve 13 is mounted on the tapered portion 3 of the drilling-out aid device 1.

The outer sleeve 13 further comprises, in the outer peripheral region, a through-hole 17, into which an associated securing pin 19 can be fitted in such a way that, at least in portions, the securing pin 19 protrudes towards the interior of the outer sleeve 13 and engages in the associated recess 9 in the tapered portion 3 of the drilling-out aid device 1, as is shown in particular in FIG. 2. The width of the recess 9 is preferably formed somewhat greater than the diameter of the securing pin 19, in such a way that the outer sleeve 13 is displaceable relative to the base body of the drilling-out aid device 1 in the longitudinal direction in accordance with the play between the recess 9 and the associated securing pin 19.

The outer sleeve 13 may be formed approximately thimble-shaped, and may for example consist of aluminum or steel. Naturally, other suitable materials are also conceivable.

To provide biased mounting of the outer sleeve 13 on the base body of the drilling-out aid device 1, the above-described rubber ring 11, when assembled, is positioned between a lower contact edge 10 of the tapered portion 3 and an upper contact edge 18 of the outer sleeve 13, as is illustrated in FIG. 2.

In connection with the rubber ring 11, the securing pin 19 secures the base body and the outer sleeve 13 against falling apart and against twisting with respect to one another. The securing pin 19 is preferably releasable from the through-hole 13 for removing the outer sleeve 13 from the base body, in such a way that for example the guide bushing 6 and/or the rubber ring can be replaced in the event of wear.

In the following, the mode of operation of the drilling-out aid device 1 in accordance with the first embodiment of the disclosure herein is described in greater detail.

By gripping the handle portion 2, the user places the drilling-out aid device 1 in accordance with the above-described first embodiment on the projecting head of the rivet to drilled out, by way of the receiving opening 14 of the outer sleeve 13, in such a way that the distal outer face of the outer sleeve 13 comes into contact with the surface of the component to be joined, which comprises the rivet. As a result of this stable contact, in connection with the rivet head being received in an approximately exact fit in the receiving opening 14 of the outer sleeve 13, the drilling-out aid device 1 is orientated centrically on the head of the blind rivet to be drilled. Subsequently, the user exerts a compressive force, directed downwards in the longitudinal direction, on the handle portion 2 counter to the spring force of the rubber ring 11, in such a way that the contact face 8 of the tapered projection 7 of the base body firmly grips the head of the rivet to be drilled out and thus prevents the rivet head from being entrained in rotation during the drilling-out process. Subsequently, using a suitable drilling tool, of which the drilling shaft protrudes through the through-hole 5, the guide bushing 6 and the tapered projection 7, the head of the blind rivet to be drilled out is reached centrically and drilled out in a predetermined, reproducible manner. The downwardly directed adjusting movement of the base body relative to the outer sleeve 13 is implemented on the one hand by way of the spring force of the rubber ring 11 and by way of the play between the securing pin 19 and the associated recess 9. Advantageously, when the drilling-out aid device 1 is not loaded with pressure, the distance between the lower outwardly directed edge of the receiving opening 14 and the contact face 8 of the tapered projection 7 is approximately equal to or somewhat greater than the height of the head of the rivet to be drilled out. As a result, when the drilling-out aid device 1 is placed on the material of the components to joined, planar contact of the distal end face of the drilling-out aid device 1 is achieved, and the rivet head is firmly gripped by way of a relative movement of the base body. However, it is obvious to a person skilled in the art that other dimensions are also possible, and can also bring about a functional drilling-out aid device 1. All that is of decisive importance is that, when the tool is placed on, a centric orientation thereof is brought about, and when the base body is loaded with pressure, the rivet head is firmly gripped.

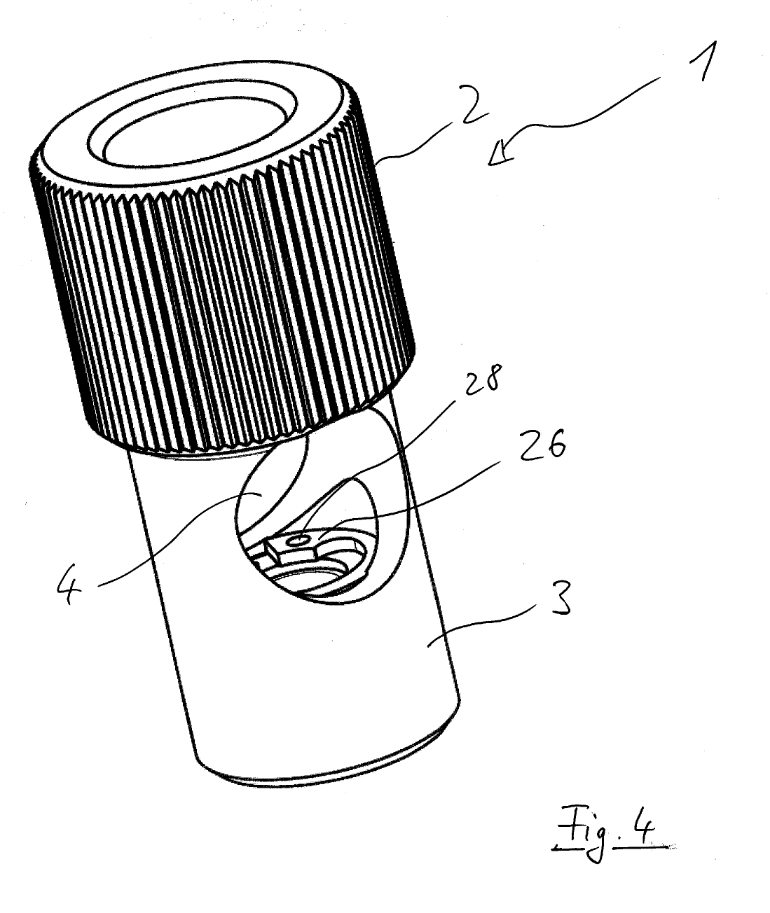

In the following, referring to FIGS. 4 to 6, a drilling-out aid device 1 in accordance with a second embodiment of the disclosure herein is described in greater detail. As can be seen in particular from FIG. 4, the drilling-out aid device 1 in accordance with the second embodiment likewise consists of a base body which is composed of a proximal handle portion 2 having a hollow cylindrical shape and a tapered portion 3 having a hollow cylindrical shape distally adjacent thereto. The base body may again be made for example of aluminum or steel or another suitable material.

In accordance with the second embodiment, the handle portion 2 has for example a profiling, formed of grooves extending in the longitudinal direction, for improving the handling when the drilling-out aid device 1 is gripped. Naturally, other profilings may also be provided. It is also conceivable for the handle to be formed from a smooth surface.

In the tapered portion 3, a transversely tapered through-opening 4 is for example provided, in particular close to the handle portion 2, and is used for ejecting produced chips during the drilling process.

Further, a receiving opening 14 is provided in the end face on the distal end face of the tapered portion 3, and the dimension thereof is adapted in an approximately exact fit to the geometric dimensioning of the head of the respective rivet to be drilled out.

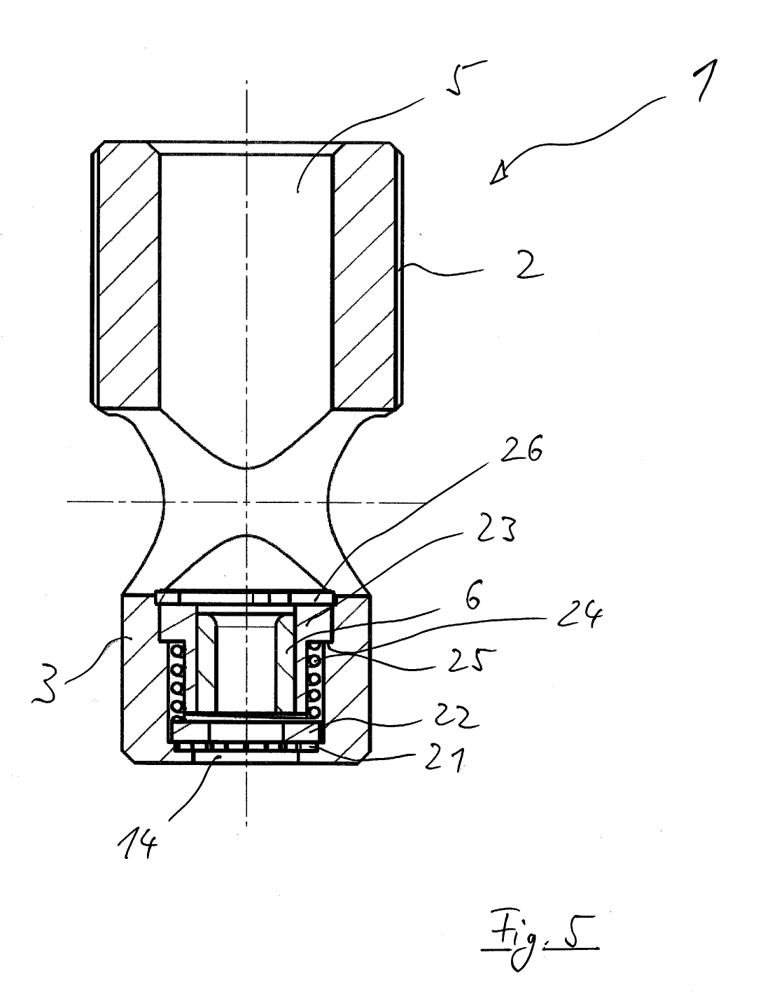

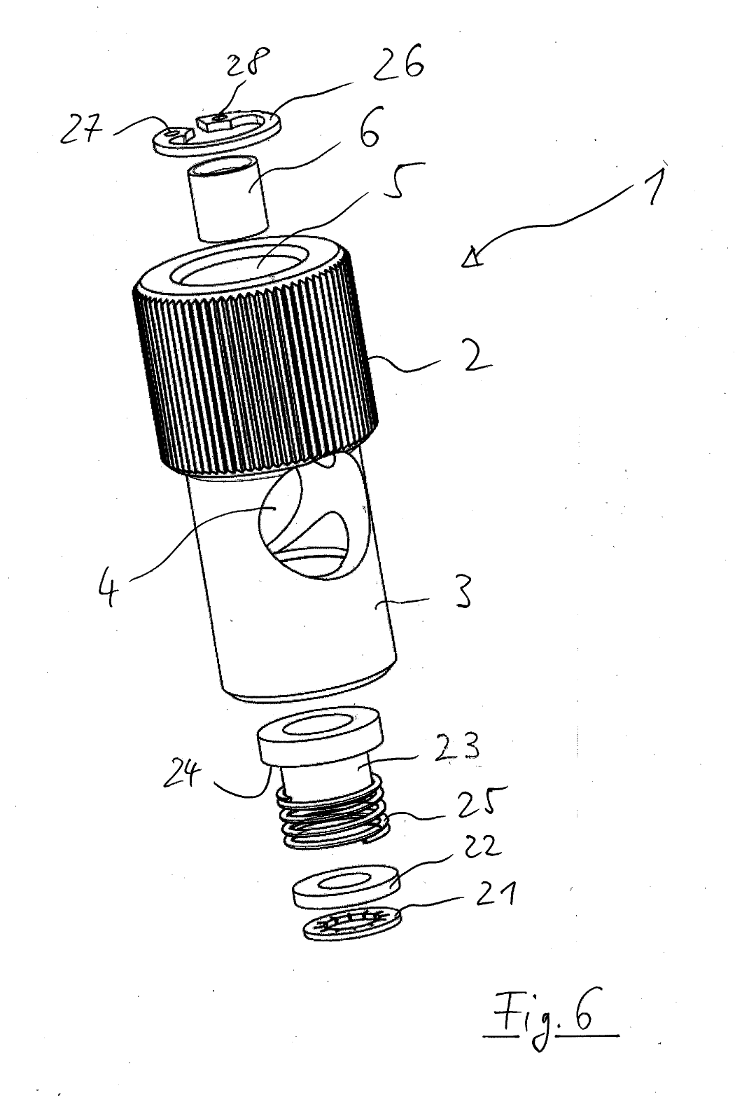

Further, as is illustrated in particular in FIGS. 5 and 6, the drilling-out aid device 1 comprises a pressure disc 21, which is in the form of for example a slotted pressure disc 21 comprising a plurality of segments. The pressure disc 21 is formed for example from metal or another suitable material, and comprises a central through-opening. The individual slotted segments of the pressure disc 21 ensure increased static friction upon contact with the generally convexly curved head of the rivet to be drilled out, which protrudes through the receiving opening 14 and can be brought into contact with the facing face of the pressure disc. It is obvious to a person skilled in the art that the pressure disc 21 may also be formed as a continuous ring or in another shape, as long as sufficient static friction is ensured between the surface, facing the rivet head, of the pressure disc 21 and the rivet head, for said rivet head to be firmly gripped during the riveting process.

In accordance with the second embodiment, the drilling-out aid device 1 comprises a force transmission disc 22, arranged above the pressure disc 21 and in contact with the pressure disc 21.

The drilling-out aid device 1 further comprises a counter bearing 23, into which, on the one hand, a guide bushing 6 having a central through-opening is pressed, and which, on the other hand, is used for supporting a spring 25 by a contact edge 24, as is illustrated in particular in FIGS. 5 and 6.

At this point, it should be noted that the pressure disc 21 and the force transmission disc 22 may also be formed as a single-piece component. All that is of decisive importance is that the face facing the head of the rivet is formed appropriately for firmly gripping the rivet head and the face facing the handle portion 2 brings about a force transfer to the spring 25.

Alternatively, the counter bearing 23 and the guide bushing 6 may also be formed in a single piece if desired.

Further, as is shown in particular in FIG. 5, the drilling-out aid device 1 comprises a securing ring 26, which is formed for example as a snap ring or the like. The securing ring 26 is for example clamped in a lateral ring groove, arranged on the internal periphery, of the drilling-out aid device 1, in such a way that the counter bearing 23, the guide bushing 6, the spring 25, the force transmission disc 22 and the pressure disc 21 are held in a predetermined position. Referring to FIG. 5, the securing ring 26 is for example formed so as to be discontinuous, and comprises engagement openings 27, 28 respectively on the two end regions. These engagement openings 27, 28 are used for engaging a corresponding securing-ring replacement tool in such a way that, by this tool, the securing ring 26 is compressed and can be removed from the associated annular groove of the drilling-out aid device 1 through the transversely extending through-opening 4. Subsequently, damaged or worn components, such as the pressure disc 21, the force transmission disc 22, the counter bearing 23, and/or the spring 25 can be replaced.

The drilling-out aid device 1 in accordance with the second embodiment may be dimensioned in such a way that the distance between the lower end-face edge of the receiving opening 14 and the rivet-head contact face of the pressure disc 21 is smaller than the height of the head of the rivet to be drilled out.

In the following, the mode of operation of the drilling-out aid device 1 in accordance with the second embodiment is described in greater detail. The user places the drilling-out aid device 1 on the rivet head of the rivet to be drilled out, by way of the receiving opening 14, in such a way that the distal end face of the drilling-out aid device 1 is positioned on the surface of the component to be joined. This ensures a centric orientation of the drilling-out aid device 1 on the head of the rivet to be drilled. As a result of the above-described dimensioning, when received the rivet head thus pushes the pressure disc 21 upwards towards the handle portion 2 and via the force transmission disc 22 counter to the spring force of the spring 25. As a result, a downwardly directed compressive force is exerted on the rivet head by the spring 25, the force transmission disc 22 and the pressure disc 21, in such a way that the rivet head is secured in place for a subsequent drilling process so as to prevent the rivet head from being entrained in rotation. This bias can be varied by way of appropriate dimensioning of the tool and appropriate selection of the spring strength of the spring 25, depending on the application requirement.

Subsequently, the drilling tool to be used is passed through the through-hole 25, the guide bushing 6 and the central through-opening of the force transmission disc 2 and the pressure disc 21 is passed through the drilling-out aid device 1, and they are centrically orientated, it subsequently being possible to drill out the rivet head in a reproducible manner.

The drilling-out aid device 1 according to the disclosure herein thus has the advantage that because of the centric orientation of the drilling tool the user does not slip from the head of the rivet to be drilled out and damage to the surrounding material is advantageously prevented. Further, the chips of the removed rivet material are ejected from the drilling-out aid device 1, in such a way that during further drilling processes these chips cannot cause scratches or component surface damage. Further, because the rivet head is firmly gripped, the rivet is prevented from being entrained in rotation and damage to the component surface is thus prevented.

Although the disclosure herein has been disclosed in the above by way of preferred embodiments, it is not limited thereto, but can be modified in various ways. Features of the above-disclosed embodiments may also be combined with one another if required. Material properties which have been disclosed in relation to the first embodiment are analogously applicable to the second embodiment.

While at least one exemplary embodiment of the disclosure herein(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A drilling-out aid device for assisting in drilling out a rivet, in particular a blind rivet, by a drilling tool, comprising:
a proximal handle portion for handling the drilling-out aid device;
a guide device for centrically guiding a drilling shaft of the drilling tool;
a distal rivet-head receiving device for centrically orientating the drilling-out aid device on the head of the rivet to be drilled out; and
a rivet-head pressing device, which is mounted displaceably in the longitudinal direction of the drilling-out aid device relative to the rivet-head receiving device for applying a centric gripping force to the head of the rivet to be drilled out.

2. The drilling-out aid device according to claim 1, wherein the proximal handle portion, the guide device and the rivet-head pressing device form a base body of the drilling-out aid device, on the distal outer periphery of which base body an outer sleeve comprising the rivet-head receiving device is mounted displaceably in the longitudinal direction relative to the base body.

3. The drilling-out aid device according to claim 2, wherein the distal rivet-head receiving device is in the form of a receiving opening, adapted to the diameter of the rivet head to be drilled out, on the underside of the outer sleeve which is displaceable in the longitudinal direction.

4. The drilling-out aid device according to claim 2, wherein the displaceable outer sleeve is mounted so as to be biased on the base body by a spring device and an associated securing structure.

5. The drilling-out aid device according to claim 4, wherein the securing structure comprises a securing pin, engaging in a recess, having clearance, in the outer peripheral region of the rivet-head pressing device, and the spring device is in the form of an annular rubber ring.

6. The drilling-out aid device according to claim 2, wherein the rivet-head pressing device is in the form of a distal contact face, having a central through-opening and adapted to the shape of the head of the rivet to be drilled out, of the base body.

7. The drilling-out aid device according to claim 6, wherein the drilling-out aid device is dimensioned such that the head of the rivet to be drilled out can be received centrically in the receiving opening, and can be secured in place by exerting pressure on the base body counter to the spring force of the spring device, by placing under pressure the distal contact face on the head of the rivet to be drilled out.

8. The drilling-out aid device according to claim 1, wherein the proximal handle portion, the guide device and the rivet-head pressing device form a base body, comprising an internal space, of the drilling-out aid device, in the internal space of which base body the rivet-head pressing device is mounted displaceably in the longitudinal direction relative to the base body, at least in part.

9. The drilling-out aid device according to claim 8, wherein the distal rivet-head receiving device is in the form of a receiving opening, adapted to the diameter of the rivet head to be drilled out, on the underside of the base body.

10. The drilling-out aid device according to claim 8, wherein the rivet-head pressing device comprises a spring device mounted in the base body and a pressure disc which has a central through-hole and which is resiliently biased towards the underside of the drilling-out aid device by the spring device.

11. The drilling-out aid device according to claim 10, wherein the pressure disc comprises a pressure face having an increased coefficient of static friction in relation to the head of the rivet to be drilled out.

12. The drilling-out aid device according to claim 11, wherein the drilling-out aid device is dimensioned in such a way that the head of the rivet to be drilled out can be received centrically in the receiving opening and can be secured in place by exerting pressure on the base body counter to the spring force of the spring device, by placing under pressure the pressure face of the pressure disc on the head of the rivet to be drilled out.

13. The drilling-out aid device according to claim 10, wherein the drilling-out aid device comprises a securing device which is formed so as to be dismountable and which secures the guide device, the spring device and/or the pressure disc in place when mounted.

14. The drilling-out aid device according to claim 1, further comprising: a transversely extending through-opening for discharging drilling chips.

15. The drilling-out aid device according to claim 1, wherein the guide device is in the form of a guide bushing, adapted to the drilling tool to be used, for centrically guiding the drilling shaft of the drilling tool.
